(19) United States
(12) Patent Application Publication
(10) Pub. No.: US 2010/0294316 A1
(43) Pub. Date: Nov. 25, 2010

(54) Tube Cleaning Device

(75) Inventors: Michael Antal, Slippery Rock, PA (US); Brian Antal, Fombell, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ITC, INC., Ellwood City, PA (US)

(21) Appl. No.: 12/469,036

(22) Filed: May 20, 2009

(51) Int. Cl. B08B 9/032; B08B 9/00; B05D 3/00

(52) U.S. Cl. 134/22.12; 15/104.05; 427/331

(57) ABSTRACT

A tube cleaning device with a shaft having a front end and a rear end defining a length therebetween is provided. The tube cleaning device has a plurality of projections extending from the shaft in a spiral configuration around the length of the shaft. The shaft and the plurality of projections are made of metal and have a polymeric coating thereon. The shaft and the plurality of projections may be composed of stainless steel. The polymeric coating is a natural or synthetic rubber material. A method of making the tube cleaning device and a method of using the tube cleaning device are also provided.

### BACKGROUND OF THE INVENTION

1. Field of the Invention

The present invention is related to a tube cleaning device, a method for providing same, and a method of using same.

2. Description of Related Art

A number of tube cleaning devices are currently available. These devices generally have a shaft member with a number of projections extending from the shaft member. Users of these devices typically apply a high pressure liquid or air force to the cleaning device placed within a tube to be cleaned so that, while the cleaning device passes through the tube, the projections scrape against the inner surface of the tube and remove deposited material from the inner surface of the tube. The projections of the tube cleaning devices are composed of molded pieces of metal, hard or soft rubbers, or nylon fibers. However, it would be desirable for the projections to have the strength and scraping ability of metal combined with the flexibility and relative liquid and air impenetrability of a polymeric material. Additionally, in some industries and facilities, such as power plants, tubes that need to be cleaned are in a Foreign Material Exclusion Area (FMEA). In an FMEA, it is imperative that materials from a tube cleaning device, such as bristles or fibers, are not left in the tube as a result of dislodgment while moving through the tube while cleaning.

Therefore, it is an object of the present invention to provide a tube cleaning device having polymeric-coated metal projections, a method for making the tube cleaning device, and a method of using the tube cleaning device.

### SUMMARY OF THE INVENTION

The present invention provides a tube cleaning device with a shaft having a front end and a rear end defining a length therebetween. The tube cleaning device has a plurality of projections extending from the shaft in a spiral configuration around the length of the shaft. The shaft and the plurality of projections are made of metal and have a polymeric coating thereon. The shaft and the plurality of projections may be composed of stainless steel. The polymeric coating is a natural or synthetic rubber material. The shaft front end has a front end cap, and the shaft rear end has a rear end cap. The plurality of projections may be spaced apart from one another by 1 mm. or less. Further, the plurality of projections may be spaced apart from one another by 0.1 mm. or less.

A method of providing a tube cleaning device is also presented, having the steps of a) providing a metal shaft with a plurality of metal projections extending therefrom in a spiral configuration along a length of the shaft; b) coating the shaft and plurality of projections with a liquid polymeric material; c) allowing the liquid polymeric material to cure to the shaft and the plurality of projections. The shaft and the plurality of projections may be composed of stainless steel. The liquid polymeric coating may be a natural or synthetic rubber material. The shaft has a front end having a front end cap, and the shaft has a rear end having a rear end cap. The plurality of projections may be spaced apart from one another by 1 mm. or less. Further, the plurality of projections may be spaced apart from one another by 0.1 mm. or less.

A method of cleaning a tube is also provided, having the steps of: a) providing a tube cleaning device having a shaft with a front end and a rear end defining a length therebetween, wherein the shaft has a plurality of projections extending therefrom in a spiral configuration around the length of the shaft, and wherein the shaft and the plurality of projections are made of metal and have a polymeric coating thereon; b) inserting the front end of the shaft into a tube; c) moving the shaft through the tube via fluid pressure forces or air pressure forces, or both, exerted on the rear end of the shaft; and d) cleaning an inner surface of the tube via a scraping of the plurality of projections along the inner surface of the tube. The shaft and the plurality of projections may be composed of stainless steel. The polymeric coating may be a natural or synthetic rubber material. The shaft front end has a front end cap, and the shaft rear end has a rear end cap. The plurality of projections may be spaced apart from one another by 1 mm. or less. Further, the plurality of projections may be spaced apart from one another by 0.1 mm. or less. With this method, deposited material is removed from the inner surface of the tube via the scraping of the plurality of projections along the inner surface of the tube. Due to the spiral configuration of the plurality of projections, the shaft of the tube cleaning device of the present invention may spin in a spiraling motion as it travels through the tube during the cleaning process.

### BRIEF DESCRIPTION OF THE DRAWINGS

FIG. 1 is a perspective view of the tube cleaning device of the present invention;

FIG. 2 is an elevational view, partly in section, of the tube cleaning device of FIG. 1 within a tube; and

FIG. 3 is a cross-sectional view of the tube cleaning device of FIG. 1 within a tube taken along lines 3-3 of FIG. 2.

### DESCRIPTION OF THE PREFERRED EMBODIMENTS

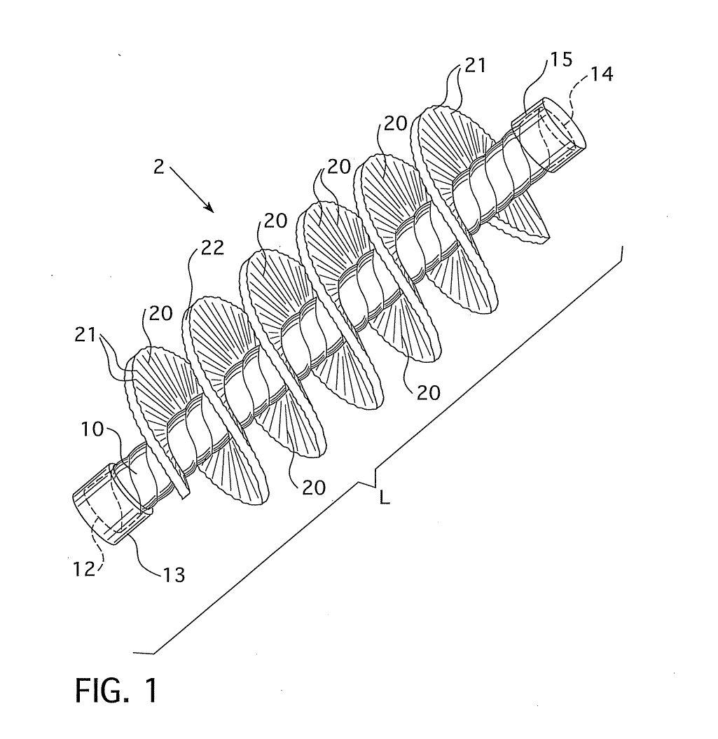

FIG. 1 illustrates a tube cleaning device 2 for cleaning tubes made in accordance with the present invention. The tube cleaning device 2 has a shaft 10 having a front end 12 and a rear end 14 defining a length L therebetween. The tube cleaning device 2 has a plurality of projections 20, such as bristles, extending from the shaft 10 in a spiral configuration around the length L of the shaft 10. Preferably, the plurality of projections 20 are resilient or may be elastically deformed and returned to their original orientation when the plurality of projections 20 are minimally deformed. Each of the plurality of projections 20 has a tip end 21. The shaft 10 and the plurality of projections 20 are made of metal and have a polymeric coating thereon. In one non-limiting embodiment, the shaft 10 and the plurality of projections 20 may be composed of stainless steel. In another non-limiting embodiment, the polymeric coating is a natural or synthetic rubber material. When the plurality of projections 20 are coated with a polymeric coating, then the tube cleaning device 2 will include a substantially continuous outer polymeric shell 22 with the plurality of projections 20 forming the core of the shell. Further, in one non-limiting embodiment, the front end 12 of the shaft 10 has a front end cap 13 and the rear end 14 of the shaft 10 has a rear end cap 15. The caps 13 and 15 are preferably made of a natural or synthetic rubber material and protect the user of the tube cleaning device 2 from being harmed by the potentially sharp front end 12 and rear end 14 of the tube cleaning device 2 during handling, insertion, and/or the exiting of the tube cleaning device 2 from a tube 40. The plurality of projections 20 may be spaced apart from one another by 1 mm. or less. In one non-limiting embodiment, the plurality of projections 20 are spaced apart from one another by 0.1 mm. or less.

As can also be appreciated by FIG. 1, a method of providing a tube cleaning device 2 is further provided herewith. With this method, a metal shaft 10 with a plurality of metal projections 20 extending therefrom in a spiral configuration along a length L of the shaft is provided. Each of the plurality of projections 20 has a tip end 21. The shaft 10 and plurality of projections 20 are coated with a liquid polymeric material via conventional methods now known or heretofore developed in the art, such as, but not limited to, spray application of the liquid polymeric material to the metal shaft 10 and the plurality of projections 20, or dipping (and subsequently removing) the metal shaft 10 and the plurality of projections 20 into the liquid polymeric material. The liquid polymeric material is allowed to cure to the shaft 10 and the plurality of projections 20 via conventional methods now known or heretofore developed in the art. In one non-limiting embodiment, the shaft 10 and the plurality of projections 20 may be composed of stainless steel. In another non-limiting embodiment, the liquid polymeric coating may be a natural or synthetic rubber material. One such material used to coat the plurality of projections 20 is a flexible acrylic, water based coating, such as Performix® Brand—HCF, which is commercially available from Plasti Dip International of Blaine, Minn. When the plurality of projections 20 are coated with a polymeric coating, then the tube cleaning device 2 will include a substantially continuous outer polymeric shell 22 with the plurality of projections 20 forming the core of the shell 22. Further, in one non-limiting embodiment, a front end cap 13 is provided over the front end 12 of the shaft 10 and rear end cap 15 is provided over the rear end 14 of the shaft 10. The caps 13 and 15 are preferably made of a natural or synthetic rubber material and protect the user of the tube cleaning device 2 from being harmed by the potentially sharp front end 12 and rear end 14 of the tube cleaning device 2 during handling, insertion, and/or the exiting of the tube cleaning device 2 from a tube 40. The plurality of projections 20 may be spaced apart from one another by 1 mm. or less. In one non-limiting embodiment, the plurality of projections 20 are spaced apart from one another by 0.1 mm. or less.

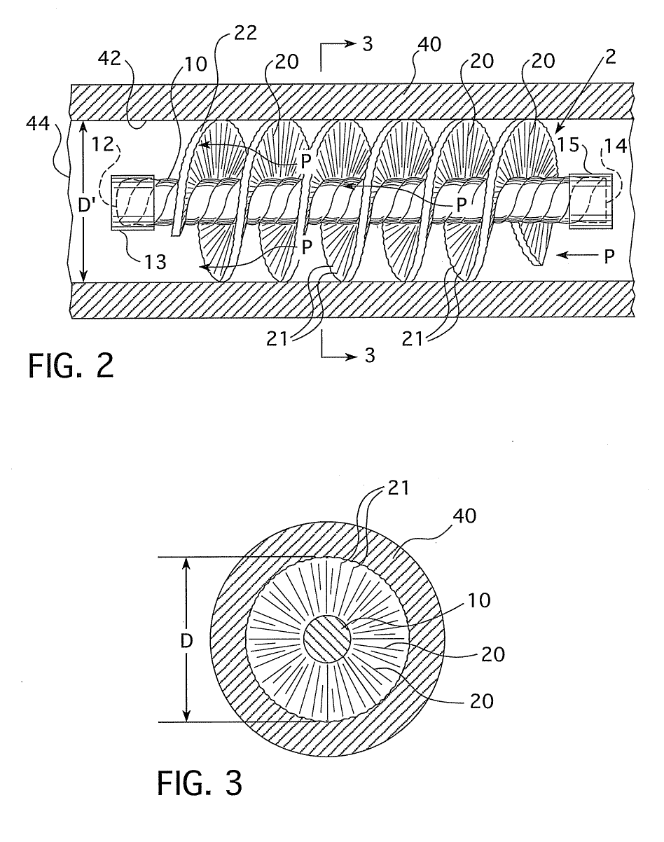

As shown in FIGS. 2 and 3, the tube cleaning device 2 of the present invention is adapted to be received within a tube 40 having an inner surface 42. Preferably, the outer diameter D of the tube cleaning device 2 is greater than the inner diameter DI of the tube 40. For example, the difference between the two diameters (D, D′) should be on the order of several thousandths of an inch. In this manner, when the tube cleaning device 2 is inserted into the tube 40, the plurality of projections 20 will be in scraping contact with the inner surface 42 of the tube 40.

In operation, and as can be readily appreciated by FIG. 2, a method of cleaning a tube 40 via a tube cleaning device 2 is also provided by the present invention. With this method, a tube cleaning device 2 having a shaft 10 with a front end 12 and a rear end 14 defining a length L (shown on FIG. 1) therebetween is provided. The shaft 10 has a plurality of projections 20 extending therefrom in a spiral configuration around the length L (shown on FIG. 1) of the shaft 10. Each of the plurality of projections 20 has a tip end 21. The shaft 10 and the plurality of projections 20 are made of metal and have a polymeric coating thereon. In one non-limiting embodiment, a front end cap 13 is provided over the front end 12 of the shaft 10 and rear end cap 15 is provided over the rear end 14 of the shaft. The caps 13 and 15 are preferably made of a natural or synthetic rubber material and protect the user of the tube cleaning device 2 from being harmed by the potentially sharp front end 12 and rear end 14 of the tube cleaning device 2 during handling, insertion, and/or the exiting of the tube cleaning device 2 from a tube 40. The front end 12 of the shaft 10 is inserted into a tube 40 to be cleaned. The shaft 10 is then moved through the tube 40 via high fluid (such as water) pressure forces or high air pressure forces, or both, exerted on the rear end 14 of said shaft 10 via conventional means now known or heretofore developed in the art, such as with the assistance of a water gun, air gun, or a pump system. The high fluid pressure forces or high air pressure forces, or both, represented as P in FIG. 2, force the tube cleaning device 2 to move through the tube 40 toward an exit end of the tube 44. As such, the inner surface 42 of the tube 40 is cleaned via the scraping of the plurality of projections 20 along the inner surface 42 of the tube 40. After the tube cleaning device 2 exits the tube 40, the cleaning method described herein can be reused with the same tube 40 or other tubes. Due to the spiral configuration of the plurality of projections 20, one of ordinary skill in the art will readily appreciate that the shaft 10 of the tube cleaning device 2 of the present invention may spin in a spiraling motion as it travels through the tube 2 during the cleaning process. Deposited materials that can be removed from the inner surface 42 of the tube 40 with the tube cleaning device 2 of the present invention include, but are not limited to, scale deposits, manganese, calcium, lime, sticks, dirt, clams, slime, mud, silty deposits, and other deposits. The shaft 10 and the plurality of projections 20 may be composed of stainless steel. The polymeric coating may be a natural or synthetic rubber material. The plurality of projections 20 may be spaced apart from one another by 1 mm. or less. In one non-limiting embodiment, the plurality of projections 20 are spaced apart from one another by 0.1 mm. or less.

When the plurality of projections 20 are coated with a polymeric coating, then the tube cleaning device 2 will include a substantially continuous outer polymeric shell 22 with the plurality of projections 20 forming the core of the shell 22. The outer polymeric shell 22 prevents the applied high fluid pressure or high air pressure from passing between the plurality of projections 20 and, as a result, the present system is more efficient than tube cleaning devices that have uncoated projections. Further, the outer polymeric shell 22 provides a more resilient tube cleaning device 2 and it also lessens the amount of damaging abrasion to the inner surface 42 of a tube 40 during the scraping of the plurality of projections 20 along the inner surface 42 of the tube 40. Additionally, as discussed previously herein, in some industries and facilities, such as power plants, tubes 40 that need to be cleaned are in a Foreign Material Exclusion Area (FMEA). In an FMEA, it is imperative that materials from a tube cleaning device 2, such as bristles or fibers, are not left in the tube 40 as a result of dislodgment while moving through the tube 40 during cleaning. The outer polymeric shell 22 of the present invention prevents the plurality of projections 20 from dislodging from the shaft 10 of the tube cleaning device 2. As such, the tube cleaning device 2 provided herein is desirable for use in a FMEA. Further, many, if not all, of the tubes 40 in FMEAs have their inner surface 42 coated with an epoxy material. The front end cap 13 and rear end cap 15 of the tube cleaning device 2 prevents the tube cleaning device 2 from marring or chipping the epoxy coating while cleaning a tube 40.

As will be readily appreciated, the outer polymeric shell 22 of the tube cleaning device 2 will eventually wear away from the tip end 21 of each of the plurality of projections 20 over use. As such, the plurality of projections 20 will be able to provide greater scraping ability on the inner surface 42 of the tube 40. However, the outer polymeric shell 22 will maintain its integrity and substantially envelop the plurality of projections 20 and prevent the plurality of projections 20 from being disassociated from the tube cleaning device 2 and left in a tube 40 during the cleaning process. Thus, deposited materials removed from the inner surface 42 of the tube 40 with the tube cleaning device 2 will still be captured and removed by the plurality of projections 20.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A tube cleaning device, comprising:
a) a shaft having a front end and a rear end defining a length therebetween; and
b) a plurality of projections extending from said shaft in a spiral configuration around said length of said shaft, wherein said shaft and said plurality of projections are made of metal and have a polymeric coating thereon.

2. The tube cleaning device of claim 1, wherein said shaft and said plurality of projections are composed of stainless steel.

3. The tube cleaning device of claim 1, wherein said polymeric coating is a natural or synthetic rubber material.

4. The tube cleaning device of claim 1, wherein said shaft front end has a front end cap and said shaft rear end has a rear end cap.

5. The tube cleaning device of claim 1, wherein said plurality of projections are spaced apart from one another by 1 mm. or less.

6. The tube cleaning device of claim 1, wherein said plurality of projections are spaced apart from one another by 0.1 mm. or less.

7. A method of providing a tube cleaning device, comprising the steps of:
a) providing a metal shaft with a plurality of metal projections extending therefrom in a spiral configuration along a length of said shaft;
b) coating said shaft and plurality of projections with a liquid polymeric material; and
c) allowing said liquid polymeric material to cure to said shaft and said plurality of projections.

8. The method of providing a tube cleaning device of claim 7, wherein said shaft and said plurality of projections are composed of stainless steel.

9. The method of providing a tube cleaning device of claim 7, wherein said liquid polymeric coating is a natural or synthetic rubber material.

10. The method of providing a tube cleaning device of claim 7, wherein said shaft has a front end having a front end cap and said shaft has a rear end having a rear end cap.

11. The method of providing a tube cleaning device of claim 7, wherein said plurality of projections are spaced apart from one another by 1 mm. or less.

12. The method of providing a tube cleaning device of claim 7, wherein said plurality of projections are spaced apart from one another by 0.1 mm. or less.

13. A method of cleaning a tube, comprising the steps of:
a) providing a tube cleaning device having a shaft with a front end and a rear end defining a length therebetween, wherein said shaft has a plurality of projections extending therefrom in a spiral configuration around said length of said shaft, and wherein said shaft and said plurality of projections are made of metal and have a polymeric coating thereon;
b) inserting said front end of said shaft into a tube;
c) moving said shaft through said tube via fluid pressure or air pressure, or both, exerted on said rear end of said shaft; and
d) cleaning an inner surface of said tube via a scraping of said plurality of projections along said inner surface of said tube.

14. The method of cleaning a tube of claim 13, wherein said shaft and said plurality of projections are composed of stainless steel.

15. The method of cleaning a tube of claim 13, wherein said polymeric coating is a natural or synthetic rubber material.

16. The method of cleaning a tube of claim 13, wherein said shaft front end has a front end cap and said shaft rear end has a rear end cap.

17. The method of cleaning a tube of claim 13, wherein said plurality of projections are spaced apart from one another by 1 mm. or less.

18. The method of cleaning a tube of claim 13, wherein said plurality of projections are spaced apart from one another by 0.1 mm. or less.

19. The method of cleaning a tube of claim 13, wherein a deposited material is removed from said inner surface of said tube via said scraping.

20. The method of cleaning a tube of claim 13, wherein said shaft spins in a spiraling motion as it moves through said tube.
